(19) United States
(12) Patent Application Publication
(10) Pub. No.: US 2016/0155138 A1
(43) Pub. Date: Jun. 2, 2016

(54) Method and System for Centralized Online Management of Referral Services

(71) Applicant: Kuising Wang, Flushing, NY (US)

(72) Inventor: Kuising Wang, Flushing, NY (US)

(21) Appl. No.: 14/556,140

(22) Filed: Nov. 29, 2014

(51) Int. Cl. G06Q 30/02

(52) U.S. Cl. CPC G06Q 30/0214

(57) ABSTRACT

A business method and related computer system of implementation is proposed for effectively fixing communication mismatch between OFFER providers and OFFER consumers by bridging up the OFFER providers' existing OFFER referral programs with a centralized, public online OFFER listing board, thereby taking advantage of said listing board's ease of access and vast reach as well as said OFFER referral program's low cost, effectiveness and efficiency while canceling out their weaknesses to maximize process efficiency, consumer quality and lower cost for said OFFER providers, maximize consuming efficiency and fairness for said consumers, and to maximize earning chances for said referrers in the system. Here OFFER refers to anything of commercial value said providers provide or produce; its exact meaning depends on the field of application to which the proposed method is applied. It can be a product, a service, a grant, an investment, an access, an opportunity or any other entity of commercial value to the parties involved. An embodiment in the field of online recruitment is described in detail where the OFFER is a job offer and the parties involved are employers, job referrers and job seekers.

### BACKGROUND OF THE INVENTION

1. Field of the Invention

The present invention relates to effective management of communications between OFFER providers and OFFER consumers, where OFFER refers to any service or good of commercial value. More particularly, the present invention relates to effectively fixing communication mismatch between OFFER providers and OFFER consumers by bridging up the OFFER providers' existing OFFER referral programs with a centralized, public online OFFER listing board, thereby enhancing the strengths and cancelling out the weaknesses of both approaches, resulting in a system with low cost, high efficiency and broad reach to benefit all parties involved—OFFER providers, referrers and consumers.

2. Description of Related Technology

The present invention is inspired by the author's experience in and observation of problems in the field of employment recruitment, so a description of the existing state of this field provides a clearer understanding of the problem in general.

In the online recruitment field, online job listing, ever since its appearance about 20 years ago, has revolutionized the field. With the popularity of internet access penetrating into the consumer world, online job listing has virtually replaced traditional paper based help wanted listings due to its ease of access from any device connected to the internet, access to larger numbers of candidates for job advertisers and almost unlimited availability of display space for more detailed job descriptions. Today, besides millions of employers' own job boards, thousands of public online job boards of all sizes ranging from niche profession-specific boards, to demographic-specific boards, to region-specific boards, to global boards and aggregation boards, are in operation.

The common problem with all these job boards is low efficiency. Years of survey by CareerXroads and recently also by iCMS show that over the last decade, while roughly 50% of hires are external, all public online job boards as a source of hire have stayed at around 20% of all external hires or only 10% of all hires every year.

While employers keep their own job boards, they do not have enough job seeker traffic. Further addition of application tracking systems (ATS) may have made Human Resources (HR)'s job easier, but their complexity further drives away potential job seekers. For those who do get through the ATS pages and submit their resumes, their resumes end up queued after thousands of other resumes waiting to be dug out for possible openings in the remote future. In order to reach out to more qualified candidates, employers on one hand outsource part of the lead searching and screening function to recruiting agencies, with a huge cost when a hire is finally made, and on the other hand make job postings to multiple job boards, which further drives up recruitment costs. The same job posting problem exists with recruiting agencies.

The posting actions by employers and recruiting agencies result in lots of job listing repetitions and outdated job information, severely pollute the job boards. This situation is even worse at those several big job listing aggregation sites as they repeatedly grab essentially the same job postings from multiple sites. This frustrates job seekers, wastes their time and discourages their job hunting efforts. Even when an interesting posting is found and resume is submitted, job seekers usually face the same problem as they would with the employers' own job boards, a situation that further discourages their job hunting efforts. This vicious cycle makes the job boards less and less attractive as well as less and less effective over time.

Employee referral, on the other hand, has always been a low-cost and relatively efficient way of recruitment for employers due to its fast track nature. It reduces HR work, reduces hiring cost compared to other screening channels such as recruiting agencies, reduces hiring cycle, referred hires have higher retention rate, and it gives the referrers an opportunity to receive referral bonuses and influence their teams. It has consistently beaten online job boards as a source of external hire over two decades. Its popularity even increased with the advent of online social networks that enable job referrers to reach out to a larger potential candidate pool. Survey by CareerXroads shows that while on average it takes about 70 un-referred applications for the employer to make one hire for a job opening, it only takes about 10 referred applications to accomplish the same. In other words referred candidates have 4 or 5 times higher chance of getting the job. While this is all good news, there are several problems with the current employee referral programs including its passive nature, relatively low efficiency of the process, relatively low quality of the candidates and relatively low diversity of the team, and unfairness for other job seekers, all related to the very limited reach of employee networks. A common scenario is that the employee knows there is a job opening available now and some of his/her friends would be good fits for it but all of them are happy with their current jobs and are not planning for a move at the exact moment. A referrer's social network is already very limited, active job-seeking candidates with the right skills and at the right time for a particular job opening in the referrer's network is even more limited, being nonexistent for a majority of potential referrers and for most of the time. This limitedness and passive nature puts a severe limit on the quantity, quality and diversity of referred candidates and also leads to low employee referral participation rate. On the other hand, for a vast majority of more qualified job seekers out there, they know that some employers are posting attractive jobs that are ideal for them but they do not have the fast track back-door connections they need for their desired jobs at the desired companies at the right moment.

The arrival of online social networks made employee referral more popular by extending employees' social networks. However, the limitedness and passive nature of such networks in terms of offering referral services still remain. Referral information in such networks is even more scattered.

So in the current online recruitment space, there remains a huge communication mismatch between employers and job seekers. Employers are crying for more qualified candidates but cannot reach out to them effectively; qualified candidates are crying for jobs but cannot get access to the hiring managers effectively. Although online job boards are popular, easy to access and can reach vast number of job seekers, they lack the screening steps and access to direct hiring managers which lead to their low hire/application ratio and declined appeal to employer HRs. Although employee referral approach provides lower cost, higher efficiency for the employers, opportunity for referrers to receive referral bonuses and influence their teams and a feel of personal touch and direct access to hiring managers for job seekers, it still suffers from its limitedness and passive nature, even with the help of online social networks, that leads to mostly passive candidate targeting, low employee participation rate, compromised hire quantity, quality and diversity, and much unfairness to qualified outside candidates. Employee referral today is simply not used to its full capacity.

Both approaches have strengths and weaknesses. The ideal approach is not to stick to only one side, as has been done by job listing sites on the job board side, and social networks on the employee referral side, but to integrate both approaches into a single system that combines their strengths and cancels out their respective weaknesses.

Currently all methods proposed and operations in existence in the job listing side of the field are based on online job board patents by CareerBuilder (U.S. Pat. No. 6,370,510) and Monster (U.S. Pat. No. 5,832,497) and there has been virtually no progress for almost two decades. Refinements include various methods of identifying candidates, and profile matching between job descriptions and candidate qualifications.

All methods proposed and operations in existence to put employee referral online focus on creating a market place where job referrers and job seekers can sign a contract to exchange money incentive for a referral, such as pioneered by Hotjobs.com (U.S. Pat. No. 6,457,005) and numerous refinements such as the one by Sheperd (U.S. Pat. No. 8,249,995). Such systems focus on the management of contract and exchange between the referrers and seekers; referral is traded as a commodity.

Other methods proposed and operations in existence in the employee referral side of the field focus on referral tracking and management, such as Application Tracking Systems (ATS). These are for situations where the candidates have already been identified. They solve a totally different HR problem.

No effective solution to the problem of communication mismatch between employers and job seekers has been proposed or currently exists, that is what this present invention is trying to address.

Although we described the situation in the field of online recruitment as an example for sake of easy understanding, the problem of communication mismatch between OFFER providers and OFFER consumers exists in a more general setting wherever qualified consumers are wanted and OFFER referral programs can be practically implemented. Examples include the fields of healthcare, insurance, direct marketing, multi-level marketing, trade, wholesale, retail, contracting, outsourcing and fund raising, to name a few. In such fields, the said problem exists in more or less the same state, and no effective solutions exist to cope with it. The present method provides such a solution

### SUMMARY OF THE INVENTION

The proposed method and related computer system aim to effectively fix communication mismatch between OFFER providers and OFFER consumers by way of combining the OFFER providers' existing OFFER referral programs with a centralized, public online OFFER listing board, thereby taking advantage of said listing board's ease of access and vast reach as well as said OFFER referral program's low cost, effectiveness and efficiency while canceling out the shortcomings of both to maximize process efficiency, consumer quality and lower cost for said providers, maximize consuming efficiency and fairness for said consumers, and to maximize earning chances for said referrers in the system. Here OFFER denotes anything of commercial value said providers provide or produce; its exact meaning depends on the field of application to which the proposed method is applied. It can be a product, a service, a grant, an investment, an access, an opportunity or any other entity of commercial value to the parties involved. An embodiment in the field of online recruitment is described in detail where the OFFER is a job offer and the parties involved are employers, job referrers and job seekers.

The proposed method, implemented with a centralized online OFFER listing board hosted on a website, allows:
(a), OFFER referrers of providers having active OFFERs to register for accounts with said website and post one or more of said OFFER descriptions for a certain time period together with said referrers' referral qualification information tied to the specific postings;
(b), representatives of said providers to post one or more OFFER descriptions for a certain time period and referrers of said providers to claim referral rights to one or more of said OFFER postings by submitting their referral qualification information tied to the specific postings;
(c), OFFER consumers, with or without registration, to access said online OFFER listing board, browse or search for OFFER postings based on certain attributes including, where applicable but not limited to, referrer information, referral information, location, provider information, category, quality, features and keywords, view OFFER descriptions and corresponding referrer qualification details as well as said referrers' referral history and any feedback about said referrers, said provider and said offer, and choose to engage in further contact with one or more referrers to start the referral process independently;
(d), OFFER consumers to request from OFFER providers that referrers be assigned and referral information be made available for the OFFER posting of interest if no referrer is attached to it so consumers can contact the referrers directly.

The online OFFER listing board consists of:
(a), a database for storing OFFER poster, OFFER referrer and OFFER consumer accounts information including personal, contact and employment related data; for storing details of the OFFER postings; and for storing OFFER referral qualification information for each OFFER referrer tied to said OFFER postings;
(b), a computer file storage for storing any electronic form of files said OFFER consumer may upload to the site for easing online application, which in the field of online recruitment can be job seekers' resumes and cover letters;
(c), a computer program for managing user accounts, accounting, OFFER posting, searching, referral request, online application and feedback activities;
(d), a set of web pages for interacting with users, servicing OFFER posting, referral rights claiming for the OFFER posters and referrers as well as OFFER browsing, searching, referral request, online application and feedback activities for the OFFER consumers.

Central to the method and system is the introduction of referral qualification information which serves as the critical link between the online OFFER listing board and the OFFER providers' referral programs. Related methods presented in the claims for managing the referrers, referral qualification information and referral claim processes combine to open the OFFER referral door to the general public consumers and allow all parties involved to take full advantage of said providers' referral programs.

For the OFFER providers, it promotes their use of OFFER referral programs, reduces their reliance on costly outside promoting/screening agencies and reduces their need to post OFFER listings on confusing and low-efficiency multiple OFFER listing boards. In the online recruitment field, employers also reduce their HR's involvement and burden, enhance their team cooperaton, employee engagement, hire quality and diversity.

For the OFFER referrers, it increases their chances of finding qualified consumer candidates and making a successful referral thereby earning their referral bonuses, enhancing their reputation, enhance their influence on their teams and their contribution to their employers.

For the OFFER consumers, it opens the coveted door of OFFER referral to them, putting them closer to an equal footing with the referrers' inner circle candidates. In the field of online recruitment, job seekers will gain almost the same privileges otherwise exclusively available to the employees' inner circle candidates and employers' existing employees looking for internal transfer.

When applied to online recruiting, the proposed method, with unparalleled features targeting employee referral job listing, unleashes the full power of employers' employee referral programs and provides online recruitment management capabilities way beyond those offered by existing platforms.

### BRIEF DESCRIPTION OF THE DRAWINGS

FIG. 1 shows a diagrammatic illustration of the system, consisting of a backend database 101, a computer file storage 102, a computer program 103 for managing the business logic, and a set of web pages 105 for job referrers, 106 for HR job posters and 107 for job seekers to interact with the computer program 103.

### DETAILED DESCRIPTION OF THE PREFERRED EMBODIMENT

As a preferred embodiment, the method is applied to the field of online recruitment by bridging up employee referral programs with a centralized, public online job listing board service, where the provider is an employer, the referrer is an employee job referrer, the consumer is job seeker and the OFFER is a job offer. The method takes advantage of the online job board's ease of access and vast reach to active job seekers to correct the very limited accessibility and reach of employee referral programs, and at the same time takes advantage of the employee referral programs' efficiency to correct the low efficiency of online job boards, creating a system with both vast reach and high efficiency as well as low cost compared with other recruiting channels, greatly benefitting employers, employee referrers and job seekers.

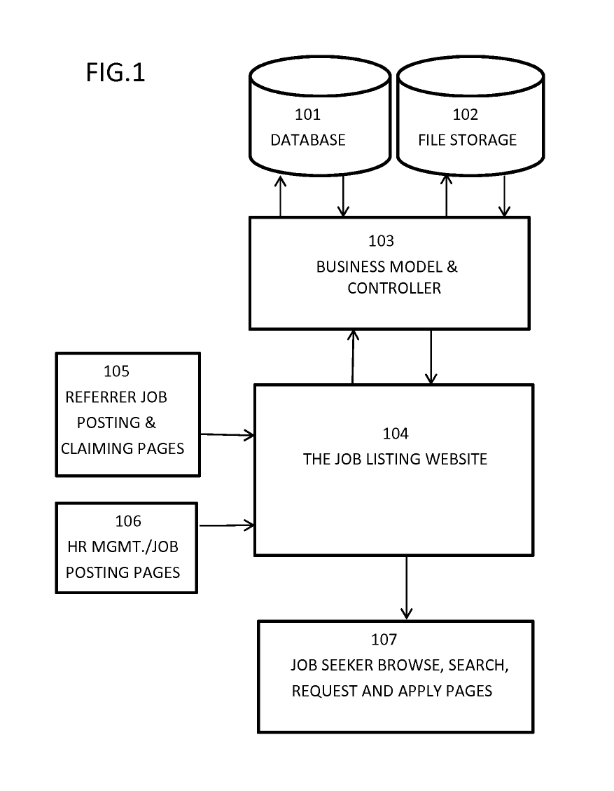

The preferred embodiment is illustrated in FIG. 1.

An internet website is set up to serve as the job listing site 104. The website consists of:
(a), a backend database 101 that stores account information for employer HR job posters, job referrers and for any job seekers who choose to register for accounts with the site, as well as information about each job posting, all referral qualification information tied to said job posting, all referrers' history and user feedback about specific employers, referrers and job postings;
(b), a computer file storage 102 for storing any resumes and cover letters job seekers may upload to the site for easy online application;
(c), a computer program 103 for managing user accounts, accounting, job posting, job referral rights claiming, job searching, referral request, online application and user feedback activities;
(d), a set of web pages 105 to service job posting and job referral rights claiming for referrers, 106 to service HR job posting and management, as well as web pages 107 to service job seeker job browsing, searching, referral request, online application and feedback activities.

Employees of employers having active job openings access the website 104, register to open accounts. At this time certain employment related information such as employer name and work email will be requested from the employees and later verified with said employers to make certain they are participating in said employers' employee referral programs to be entitled to post job descriptions on behalf of their employers and claim referral rights on the board. HR of employers having active job openings can also register to open accounts and post job openings on behalf of their employers.

Once accounts are opened, all existing active job postings together with related existing referral information from the same employer will be displayed in said account pages 105 and 106; this promotes referral collaboration. All account holders can view job seeker page view statistics related to existing job postings belonging to said employers. This helps job posters gauging the popularity and effectiveness of said job postings. All account holders can post new job postings to the board. Employees posting jobs must attach their referral qualification information in any viewable form to each job description they posted. Employees can also browse or search existing postings from their employers and claim referral rights to any posting by submitting their referral qualification information in any viewable form such as a short description of said referrers' influence on the hiring, a short description of said referrers' relationship (or closeness) with the direct hiring managers, a numerical influence ranking for example on a scale of 1 to 10, a word ranking, a link to a website, a picture, an audio clip, and even a video clip.

Job seekers with internet connection access the pages 107 on the website to browse or search for job postings based on certain job attributes including, but not limited to, job referrer information, job referral information, job location, job category, job employer information and job keywords, view job descriptions and corresponding referrer qualification details, and choose to engage in further contact with one or more referrers to start the referral process independently. They contact said referrers by ways specified by said referrers or by clicking a button to submit cover letters and resumes to the referrers directly, thus gaining access to fast track recruitment. Referrers get job seekers' resumes in any way they prefer, review the resumes, and if interested enough will communicate with the job seekers directly and conduct informal screenings in the hope of identifying the right candidate to refer for the job opening of interest. For job postings with no referral information, job seekers can request that employers assign referrers to interested job postings. System operator will pass such requests to the employers and once referral information is available, job seekers will be notified so they can apply directly with the referrers.

To maintain freshness and accuracy of the job board 104 and validity of the postings, a fee based measure, among other means, can be enacted to encourage or even force the referrers to remove any job postings that are not open to further job candidates anymore. This greatly benefits job seekers.

To promote professionalism in employee referral processes, job seekers maintaining active accounts with the website can provide feedback about employers, referrers and specific job postings. These are stored in said database 101 and displayed to all on appropriate pages.

To aid job seekers in choosing appropriate referrers for a particular job posting, all referrers' referral histories are stored in said database 101 and upon said referrers' consent and at job seekers' requests can be displayed to said job seekers in appropriate ways.

To eliminate repetition on the job board 104 and save job seekers' time, the same job descriptions from the same employer posted by multiple referrers are merged into one item displayed to the job seeker, with all referrers' qualification information and contact information, history, feedback if any, attached at the end, ordered in any way.

An example implementation of this particular embodiment is recently made available at http://www.careeref.com.

Although only one embodiment of the present invention has been described in detail, it is to be understood that the present invention is by no means limited to the scope of this particular embodiment. As was mentioned in the background section, the problem of communication mismatch between OFFER providers and OFFER consumers exists in a more general setting wherever qualified consumers are wanted and OFFER referral programs can be practically implemented. Examples include the fields of healthcare, insurance, direct marketing, multi-level marketing, trade, wholesale, retail, contracting, outsourcing and fund raising, to name a few. Wherever said problem exists, the present invention applies equally well to cope with it. Therefore a general scope of protection is sought by this application in the following claims.

I claim:

1. A business method and related computer system for effectively fixing communication mismatch between OFFER providers and OFFER consumers by bridging up said providers' existing OFFER referral programs with a centralized, public online OFFER listing board service, thereby enhancing the strengths and cancelling out the weaknesses of both approaches, resulting in a system with low cost, broad reach and high efficiency, to benefit all parties involved—OFFER providers, referrers and consumers.

2. The method of claim 1, wherein said online OFFER listing board hosted on a website comprises:
(a), a database for storing OFFER poster, OFFER referrer and OFFER consumer accounts information including personal, contact and employment related data as well as details of the OFFER postings;
(b), a computer file storage for storing any electronic form of files said OFFER consumer may upload to the site for easy online application;
(c), a computer program for managing user accounts, accounting, OFFER posting , searching, referral claiming, referral request, online application and feedback activities;
(d), a set of web pages for interacting with users, servicing OFFER posting, referral rights claiming and general management for the OFFER posters and referrers, as well as servicing OFFER browsing, searching, referral request, online application and feedback activities for the OFFER consumers.

3. The method of claim 1, wherein:
OFFER referrers of providers having active OFFERs can register for accounts with said website and post one or more OFFER descriptions for a certain time period together with said referrers' referral qualification information tied to the specific postings;
Representatives of said providers can post one or more OFFER descriptions for a certain time period and referrers of said providers can claim referral rights to one or more of said OFFER postings by submitting their referral qualification information tied to the specific postings;
OFFER consumers, with or without registration, can access the said online OFFER listing board, browse or search for OFFER postings based on certain OFFER attributes including, where applicable but not limited to, referrer information, referral information, location, provider information, category, quality, features and keywords, view OFFER descriptions and corresponding referrer qualification details as well as said referrers' referral history and any feedback about said referrers, said provider and said offer, and choose to engage in further contact with one or more referrers to start the referral process independently. For OFFER postings with no referral information, OFFER consumers can request that providers make referral available on the website so they can contact the referrers directly.

4. The method of claim 1, wherein it is required that the referrers be employees or other provider-designated individuals participating in said providers' OFFER referral programs, a qualification that is checked to certain extent at registration time and verified later to maintain the online OFFER listing board's appeal to prospective OFFER consumers.

5. The method of claim 1, wherein the referrers are required to provide referral qualification information tied to each specific OFFER they post to said online OFFER listing board, which is also stored in said OFFER board database and displayed under the OFFER descriptions to help prospective OFFER consumers decide which OFFER to consume or apply for and which one or more referrers to contact when multiple referrers post the same offer.

6. The method of claim 5, wherein the referral qualification information can be in any intelligible form, including, but not limited to, a short description of said referrers' influence on the offer, a short description of said referrers' relationship (or closeness) with the direct OFFER managers, a numerical influence ranking such as on a scale of 1 to 10, a word ranking, a link to a website, a picture, an audio clip, and a video clip.

7. The method of claim 5, wherein the referral qualification information is displayed either separately or merged with the OFFER description.

8. The method of claim 5, wherein the referral qualification information is used as a search criterion for searching OFFER postings.

9. The method of claim 1, wherein the same OFFER descriptions from the same provider posted by multiple referrers are merged into one item displayed to the consumer, with all referrers' qualification information and contact information/links attached at the end, ordered in any way.

10. The method of claim 1, wherein certain methods including, but not limited to, fee based means are employed to make certain OFFER postings will be removed promptly once they become inactive, unavailable or simply too outdated, to maintain accuracy and freshness of said online OFFER listing board.

11. The method of claim 1, wherein said referrers' referral histories are stored in said OFFER board database and upon said referrers' consent and at the consumers' requests are displayed to said consumers in appropriate ways to aid in decision making.

12. The method of claim 1, wherein OFFER consumers maintaining active accounts with the website can post feedback about OFFER providers, referrers and specific OFFER postings they have been dealing with; such info is stored in said database and displayed to all.

13. The method of claim 1, wherein all OFFER postings from the same employer are displayed to each representative OFFER poster and OFFER referrer of said provider to facilitate referral collaboration.

14. The method of claim 1, wherein OFFER consumer activity statistics such as page view numbers within a certain time period related to a particular OFFER posting is displayed in each OFFER poster/referrer's account tied to said OFFER posting to help gauging the popularity and effectiveness of said OFFER posting.

15. The method of claim 1, wherein said OFFER is a concrete or software product, said provider is a producer of said product, said consumer is a user of said product, said provider representative is producer personnel managing sales of the said product, said referrer is an employee or other designated individual of said producer, said direct OFFER manager is executive manager for selling said product, and consuming means purchasing or using said product.

16. The method of claim 1, wherein said OFFER is a service, said provider is a provider of said service, said consumer is a recipient of said service, said provider representative is provider personnel managing sales of said service, said referrer is an employee or other designated individual of said provider, said direct OFFER manager is executive manager for selling said service, and consuming means purchasing or using said service.

17. The method of claim 1, wherein said OFFER is a job opening or job offer, said provider is an employer, said consumer is an active job seeker, said provider representative is HR personnel, said referrer is an employee of said employer participating in said employer's employee referral programs, said direct OFFER manager is the direct hiring manager of said job offer, said online OFFER listing board is an online job board and consuming means applying for said job OFFER by active job seekers.

18. The method of claim 1, wherein said OFFER is an investment, said provider is an investor (angel investor, angel club or venture capital fund), said consumer is a recipient of investment, said provider representative is personnel representing the investor, said referrer is any person the investor would take referral from, said direct OFFER manager is executive investor, and consuming means getting the investment from the investor.
